(19) United States
(12) Patent Application Publication
(10) Pub. No.: US 2026/0183697 A1
(43) Pub. Date: Jul. 2, 2026

(54) METHOD FOR OPERATING A DIRECT AIR CAPTURE PROCESS INCLUDING A FRACTAL NETWORK LAYOUT

(71) Applicant: SHELL USA, INC., Houston, TX (US)

(72) Inventors: Sayee Prasaad BALAJI, Amsterdam (NL); Timothy NISBET, Amsterdam (NL)

(21) Appl. No.: 19/131,559

(22) PCT Filed: Nov. 15, 2023
(86) PCT No.: PCT/EP2023/081895

§ 371 Date: May 21, 2025

(30) Foreign Application Priority Data
Nov. 22, 2022 (EP) 22208694.4

(51) Int. Cl. B01D 53/04

(52) U.S. Cl. CPC B01D 53/0446; B01D 53/0438; B01D 2257/504; B01D 2259/4009

(57) ABSTRACT

Implementations of the disclosed subject matter provide a method for operating a direct air capture (DAC) process including a fractal network layout. The method may include providing a plurality of base units, each base unit may include a plurality of DAC modules and a primary level node. Each primary level node may be connected to each of the DAC modules within the base unit by a process connection and/or a utility connection. A secondary level unit may include the plurality of base units. The secondary level unit may include a secondary level node which may be connected to each of the primary level nodes by process and/or utility connections. The method may include receiving an air stream at each of the DAC modules, contacting the air stream with a sorbent material, generating and transporting an outlet stream comprising CO2 from each of the DAC modules to the secondary level node.

### TECHNICAL FIELD OF THE INVENTION

The present invention relates to a direct air capture (DAC) process for capturing carbon dioxide (CO₂) from the atmosphere. More specifically the present invention relates to a process for capturing carbon dioxide (CO₂) from the atmosphere using large direct air capture arrays including a fractal network layout.

### BACKGROUND

Direct air capture (DAC) of carbon dioxide from the air has been proposed as one way of addressing human induced climate change. Current estimates place global levels of carbon dioxide in the atmosphere at around 420 parts per million. This is expected to rise to around 900 parts per million by the end of the 21st century. Hence, DAC represents one of a range of technologies that can be employed to reduce the environmental impact of greenhouse gases like carbon dioxide and help the transition to a low carbon global economy.

An attractive option for direct air capture of CO₂ is a process by which CO₂ in the atmosphere is captured using a solid sorbent. Typical DAC systems take large quantities of air (or other conditioned gaseous atmosphere) which is pumped as a feedstream through a unit that contains a sorbent substance that removes the carbon dioxide from the feedstream. Over time the sorbent becomes loaded with captured carbon dioxide. Next, the captured carbon dioxide in the sorbent is extracted from the sorbent in the regeneration step. Regeneration may involve thermal or chemical processes depending upon the type of sorbent material that is selected for use in the DAC process. Upon regeneration the captured carbon dioxide is released from the sorbent and can be used to manufacture sustainable fuels, chemicals, in food and beverage production or in carbon capture and sequestration (CCS) in order to create a net negative carbon process. The energy input to the DAC system can comprise of thermal energy in the form of steam, and electrical energy for both the absorption (to move the air through the DAC unit) and regeneration (to regenerate the CO₂ from the sorbent) steps.

Because of the low CO₂ concentration in air, very large amounts of air need to be processed in order to extract industrially interesting volumes of CO₂. An industrial facility of e.g. 1000 kta capacity will typically consist of an array of many adsorption DAC modules spread over an area of several square kilometers. This is needed to ensure that sufficient air volume passes through the array under the influence of wind flows. Each DAC module, however, needs to be supplied with stripping gas (typically steam) to remove the adsorbed CO₂. Furthermore, released CO₂ needs to be collected in a central system for use or sequestration. This results in extended piping networks for both stripping gas and released CO₂ which can be of several hundred kilometers of total length. Thus, optimization of these piping networks is therefore important to minimize capital cost and to maintain optimum (high) productivity of the DAC module array operation.

### BRIEF SUMMARY

According to an embodiment of the disclosed subject matter, a method for operating a direct air capture process including a fractal network layout may include: a plurality of base units, wherein each base unit comprises a plurality of direct air capture (DAC) modules. The method may include a plurality of primary level nodes and each base unit may include a primary level node, and each primary level node may be connected to each of the DAC modules within the base unit by process and/or utility connections. The method may include a secondary level unit, and the secondary level unit may comprise the plurality of base units. A secondary level node may be located in the secondary level unit, and the secondary level node may be connected to each of the primary level nodes within the secondary level unit by a process connection and/or a utility connection. The method may further include receiving an air stream at each of the direct air capture (DAC) modules, contacting the air stream with a sorbent material located within each of the direct air capture (DAC) modules. An outlet stream comprising CO₂ may be generated from each of the direct air capture (DAC) modules and the outlet stream may be transported to the secondary level node.

Implementations of the disclosed subject matter provide a method for operating a direct air capture process including a fractal network layout. The disclosed subject matter allows for optimized piping networks and reduced costs in the overall DAC process. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example direct air capture process including a base unit according to an implementation of the disclosed subject matter.

FIG. 2 shows an example direct air capture process including a fractal network layout according to an implementation of the disclosed subject matter.

FIG. 3 shows an example direct air capture (DAC) module according to an implementation of the disclosed subject matter.

FIG. 4 shows an example direct air capture process including a fractal network layout according to an implementation of the disclosed subject matter.

FIG. 5 shows an example direct air capture process including a fractal network layout according to an implementation of the disclosed subject matter.

FIG. 6 shows an example direct air capture process including a fractal network layout according to an implementation of the disclosed subject matter.

FIG. 7 shows an example direct air capture process including a fractal network layout according to an implementation of the disclosed subject matter.

FIG. 8 shows an example direct air capture process including a fractal network layout according to an implementation of the disclosed subject matter.

FIG. 9 shows an example direct air capture process including a fractal network layout according to an implementation of the disclosed subject matter.

FIG. 10 shows an example direct air capture process including a fractal network layout according to an implementation of the disclosed subject matter.

### DETAILED DESCRIPTION

In general, an attractive option for direct air capture of CO₂ is a process by which CO₂ in the atmosphere is captured using a solid sorbent. Because of the low CO₂ concentration in air, very large amounts of air need to be processed in order to extract industrially interesting volumes of CO₂. As an example, an industrial facility of e.g. 1000 kta capacity will typically consist of an array of many adsorption modules spread over an area of several square kilometers. This is needed to ensure that sufficient air volume passes through the array under the influence of wind flows. Each DAC module, however, needs to be supplied with stripping gas (typically steam) to remove the adsorbed CO₂. Furthermore, released CO₂ needs to be collected in a central system for use or sequestration. This results in extended piping networks for both stripping gas and released CO₂ which can be of several hundred kilometers of total length. Optimization of these piping networks is therefore important to minimize capital cost. The present invention solves this problem by implementing a fractal network layout to a method for operating a DAC module array process.

According to the presentation invention, it has been found that applying a fractal network layout gives an optimized piping network. In general, costs of pipelines are proportional to “inch-km” of piping, i.e. the pipe diameter in inches multiplied by the length in kilometers. According to the present invention, implementing a fractal layout allows the total “inch-km” of a network to be minimized, thereby reducing materials, costs, etc.

As an example, for a square array with 4 DAC modules, these may be connected with diagonal pipes to a central point. For an array with 16 DAC modules, the center points of each 4 DAC module arrays may be connected to a central point. For an array with 64 DAC modules, the center points of each 16 module arrays may be connected to a central point. For example, this may be extended to 256, 1024, 4096 modules, etc. and so on. For intermediate numbers of DAC modules, some DAC modules around the perimeter of the array may be eliminated, but the fractal interconnections of remaining DAC modules may be unchanged.

In addition, another advantage of the disclosed subject matter is that the overall cost may be optimized by, for example, installing distributed facilities for generation of stripping gas at a given node level of the fractal network, or by installing distributed CO₂ compressor stations at a given node level of the fractal network.

According to an embodiment, the present invention minimizes the overall piping and electrical connections needed in a method for operating a DAC process that includes DAC module arrays. The DAC process according to the present invention is designed in such a way that the use of a fractal network layout allows the total “inch-km” parameter of the network to be minimized and thereby reduces the overall costs of pipelines, electrical connections, equipment, etc.

A DAC module may be a module for removing CO₂ from the atmosphere by contacting an air stream with a sorbent material for absorbing CO₂. In general, a fractal is a non-regular geometric shape that has the same degree of non-regularity on all scales, being self-similar across different scales. They are created by repeating a simple process over and over in an ongoing repeating pattern.

According to an embodiment of the present invention, a method for operating a direct air capture process including a fractal network layout may include providing a plurality of base units. Each base unit may include a plurality of direct air capture (DAC) modules. The method may include providing a plurality of primary level nodes and each base unit may include a primary level node. Each primary level node may be connected to each of the DAC modules within the base unit by a process connection and/or a utility connection. The method may include providing a secondary level unit, and the secondary level unit may include the plurality of base units. A secondary level node may be located in the secondary level unit, and the secondary level node may be connected to each of the primary level nodes within the secondary level unit by a process connection and/or a utility connection.

The method may include the steps of receiving an air stream at each of the direct air capture (DAC) modules, contacting the air stream with a sorbent material located within each of the direct air capture (DAC) modules, generating an outlet stream comprising CO₂ from each of the direct air capture (DAC) modules, and transporting the outlet stream to the secondary level node.

In an embodiment, the method for operating a direct air capture process including a fractal network layout may also include providing a plurality of secondary level units and a plurality of secondary level nodes, each secondary level unit may have a secondary level node. The method may also include providing a tertiary level unit, and the tertiary level unit may include the plurality of secondary level units and the plurality of secondary level nodes. A tertiary level node may be located in the tertiary level unit, and the tertiary level node may be connected to the plurality of the primary and secondary level nodes within the tertiary level unit by a process connection and/or a utility connection.

According to an embodiment, the method for operating a direct air capture process including a fractal network layout may further include providing a plurality of tertiary level units and a plurality of tertiary level nodes, each tertiary level unit having a tertiary level node. The method may also include providing a quaternary level unit, and the quaternary level unit may include the plurality of tertiary level units and the plurality of tertiary level nodes. A quaternary level node may be located within the quaternary level unit, and the quaternary level node may be connected to the plurality of the primary, secondary, and tertiary level nodes within the quaternary level unit by a process connection and/or a utility connection.

In an embodiment the process connection may include a piping segment between any of the DAC modules, primary, secondary, tertiary, and quaternary level nodes. Each piping segment may have a pipe length measured in km and a pipe diameter measured in inches, wherein each piping segment has a piping segment value which is the product of the pipe length*pipe diameter (km*inches). An advantage of the present invention is that the sum of all piping segment values in the fractal network layout is minimized relative to a DAC process without a fractal network layout. For example, a network connecting 1024 DAC modules without a fractal layout may have 1056 piping segments of 10 different diameters with a sum of all piping segment values of 794 km*inches. On other hand, the fractal network layout, according to the present invention, connecting the same 1024 DAC modules may have 1024 piping segments of 5 different diameters with a sum of all piping segment values of 544 km*inches. As cost of the piping network is proportional to the total number of km*inches, it is an advantage of using the disclosed fractal network such that overall costs for piping are reduced relative to an operation without the disclosed fractal network.

In an embodiment, the utility connections may include an electrical cable segment between any of the DAC modules, primary, secondary, tertiary, and quaternary level nodes. Each electrical cable segment may have an electrical cable length measured in km and an electrical cable diameter measured in inches. Each electrical cable segment may have an electrical cable segment value which is the product of the electrical cable length*electrical cable diameter (km*inches). The sum of all electrical cable segment values in the fractal network layout may be minimized relative to a DAC process without a fractal network layout. For example, a network connecting 16 DAC modules without a fractal layout may have 20 electrical cable segments of 4 different diameters with a sum of all electrical cable segment values of 1.75 km*inches. On the other hand, the fractal network, according to the present invention, connecting the same 16 DAC modules may have 16 electrical cable segments of 3 different diameters with a sum of all electrical cable segment values of 1.16 km*inches. As cost of the electrical cable network is proportional to the total number of km*inches, it is an advantage of using the disclosed fractal network such that overall costs for electrical cables are reduced relative to an operation without the disclosed fractal network.

Various utilities, equipment, etc. may be located at a node within the fractal network layout. In an embodiment, the method for operating a direct air capture process including a fractal network layout may include providing at least one steam generator located at one or more of the primary, secondary, tertiary, and quaternary level nodes, for supplying steam to more than one DAC module via the process and/or utility connections.

In an embodiment, the method for operating a direct air capture process including a fractal network layout may include providing at least one intermediate compressor located at one or more of the primary, secondary, tertiary, and quaternary level nodes for receiving the outlet stream comprising CO2 from more than one DAC module via the process connections. Although not explicitly shown in the FIGS., a fractal network layout may include any number of primary, secondary, tertiary, quaternary level nodes, and may include higher level nodes, for example, quinary, senary, septenary, and so on, level nodes may be included in a direct air capture process having fractal network layout according to the disclosure subject matter.

In an embodiment, at least one condenser may be provided and located at one or more of the primary, secondary, tertiary, and quaternary level nodes for receiving the outlet stream comprising CO2 from more than one DAC module via the process connections.

According to an embodiment, at least one energy storage unit may be provided and located at one or more of the primary, secondary, tertiary, and quaternary level nodes for supplying stored energy to more than one DAC module via the process connection and/or a utility connection.

According to an embodiment, the method for operating a direct air capture process including a fractal network layout may include providing any one or more of: an electric boiler, an energy storage unit comprising a liquid heat storage medium, an air cooler, a liquid ring pump, an electrical substation, and an electrical transformer. One or more of these items may be located at one or more of the primary, secondary, tertiary, and quaternary level nodes for supplying and/or receiving process or utility streams to more than one DAC module via the process connection and/or a utility connection.

For the purposes of promoting an understanding of the principles of the invention, reference will now be made to the embodiments illustrated in the accompanying drawings, which are described in more detail below. The embodiments disclosed herein are not intended to be exhaustive or limit the invention to the precise form disclosed in the following detailed description. The invention includes any alterations and further modifications in the illustrated devices and described methods and further applications of the principles of the invention as set forth in the claims.

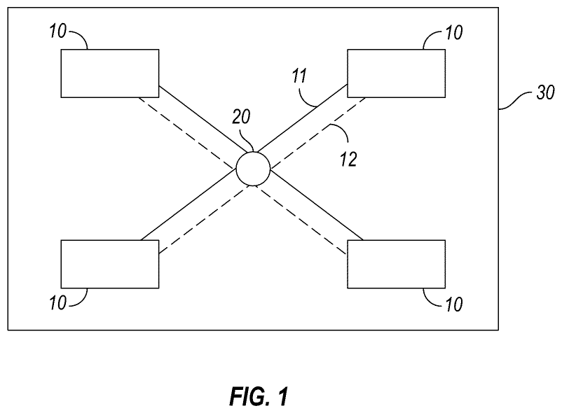

FIG. 1 shows an example direct air capture process fractal network layout according to an implementation of the disclosed subject matter. In particular, FIG. 1 shows a base unit 30. As shown, base unit 30 may include a plurality of direct air capture (DAC) modules 10. The base unit 30 may include a primary level node 20. As shown, primary level node 20 may be connected to each of the DAC modules 10 within the base unit 30 by process connections 11 and/or utility connections 12.

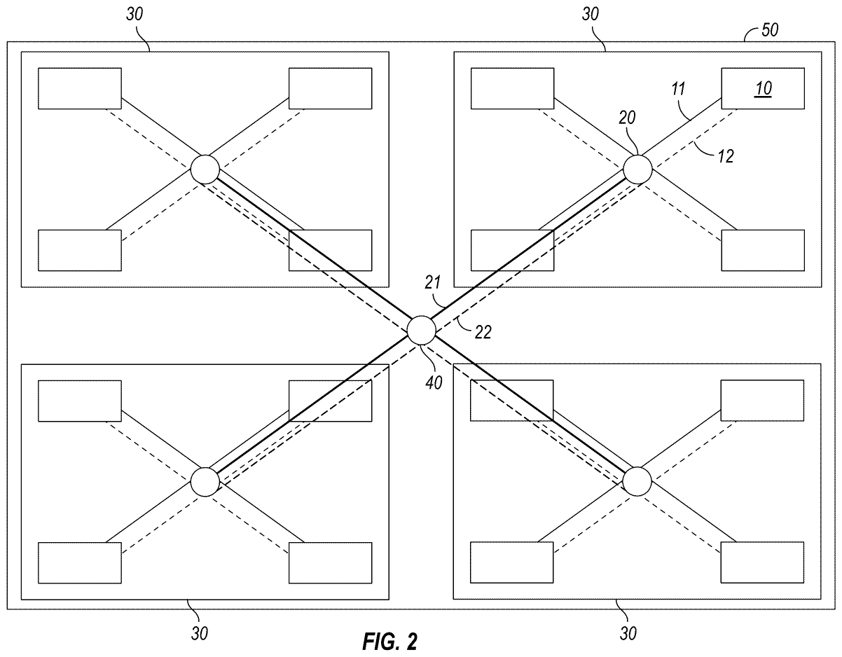

FIG. 2 shows an example direct air capture process including a fractal network layout according to an implementation of the disclosed subject matter. In particular, FIG. 2 shows a secondary level unit 50, and the secondary level unit 50 may include the plurality of base units 30. Each base unit 30 may include a plurality of DAC modules 10. Also, each base unit 30 may include a primary level node 20. As shown, each primary level node 20 may be connected to each of the DAC modules 10 within each base unit 30 by process connections 11 and/or utility connections 12. Also shown in FIG. 2, a secondary level node 40 may be located in the secondary level unit 50, and the secondary level node 40 may be connected to each of the primary level nodes 20 by process connections 21 between primary level nodes 20 and the secondary level node 40 and/or by utility connections 22 between primary level nodes 20 and the secondary level node 40.

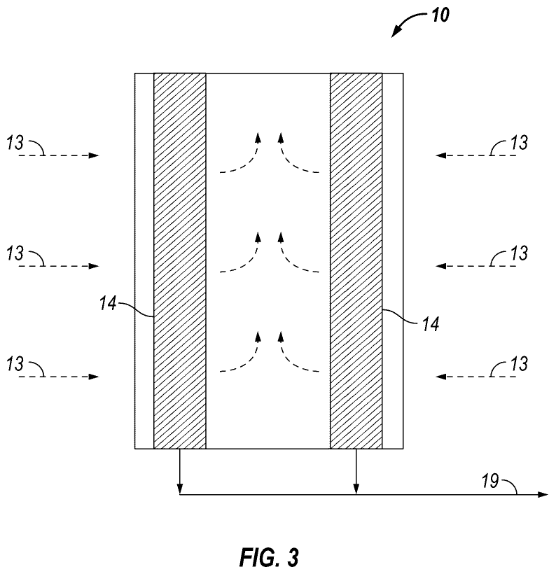

FIG. 3 shows an example direct air capture (DAC) module according to an implementation of the disclosed subject matter. Specifically, FIG. 3 shows a DAC module 10. In an embodiment, the method may include the steps of receiving an air stream 13 at the DAC module 10, contacting the air stream 13 with a sorbent material 14 located within the DAC module 10, generating an outlet stream 19 comprising CO2 from the DAC module 10, and transporting the outlet stream 19 to the secondary level node 40 (not shown in FIG. 3). As shown, the DAC module 10 may be connected to a primary level node (not shown in FIG. 3) by a utility connection 12 (also not shown in FIG. 3).

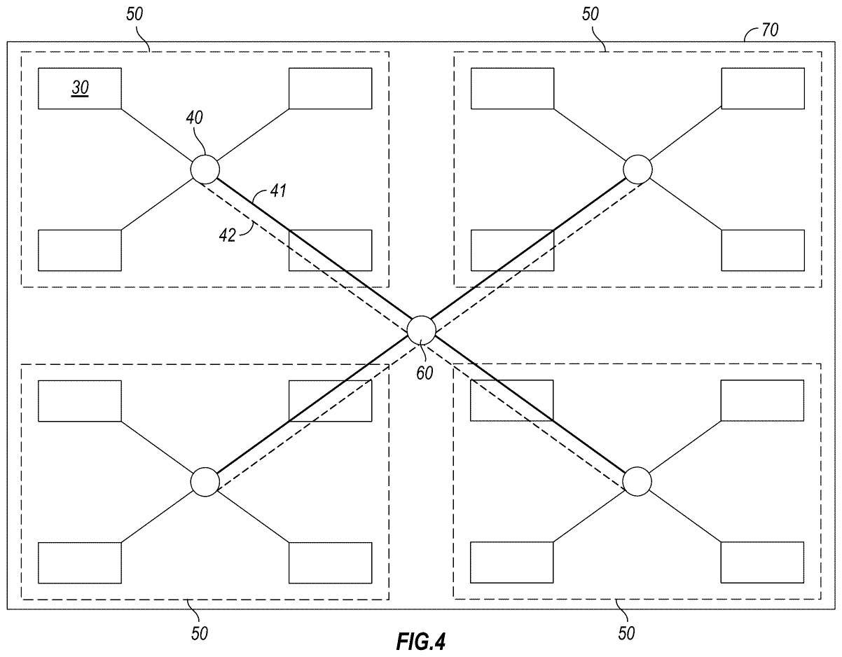

FIG. 4 shows an example direct air capture process including a fractal network layout according to an implementation of the disclosed subject matter. In particular, FIG. 4 shows a plurality of secondary level units 50 and a plurality of secondary level nodes 40, where each secondary level unit 50 may include a secondary level node 40. Also shown in FIG. 4, a tertiary level unit 70 may include the plurality of secondary level units 50 and the plurality of secondary level nodes 40. A tertiary level node 60 may be located in the tertiary level unit 70. The tertiary level node 60 may be connected to the plurality of the primary level nodes 20 (not shown) and secondary level nodes 40 within the tertiary level unit 70 by process connections 41 between secondary level nodes 40 and the tertiary level node 60 and/or by utility connections 42 between secondary level nodes 40 and the tertiary level node 60.

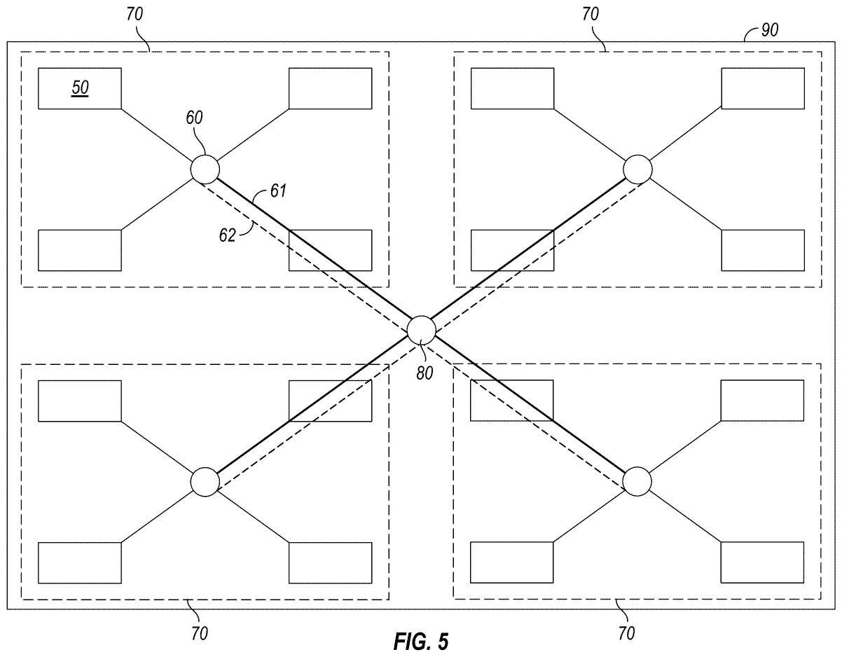

FIG. 5 shows an example direct air capture process including a fractal network layout according to an implementation of the disclosed subject matter. In particular, FIG. 5 shows a plurality of tertiary level units 70 and a plurality of tertiary level nodes 60, where each tertiary level unit 70 may include a tertiary level node 60. Also shown in FIG. 5, a quaternary level unit 90 may include the plurality of tertiary level units 70 and the plurality of tertiary level nodes 60. A quaternary level node 80 may be located within the quaternary level unit 90. The quaternary level node 80 may be connected to any of the plurality of the primary, secondary, and tertiary level nodes ((20,40 not shown in FIG. 5),60) within the quaternary level unit 90 by process connections 61 and/or utility connections 62.

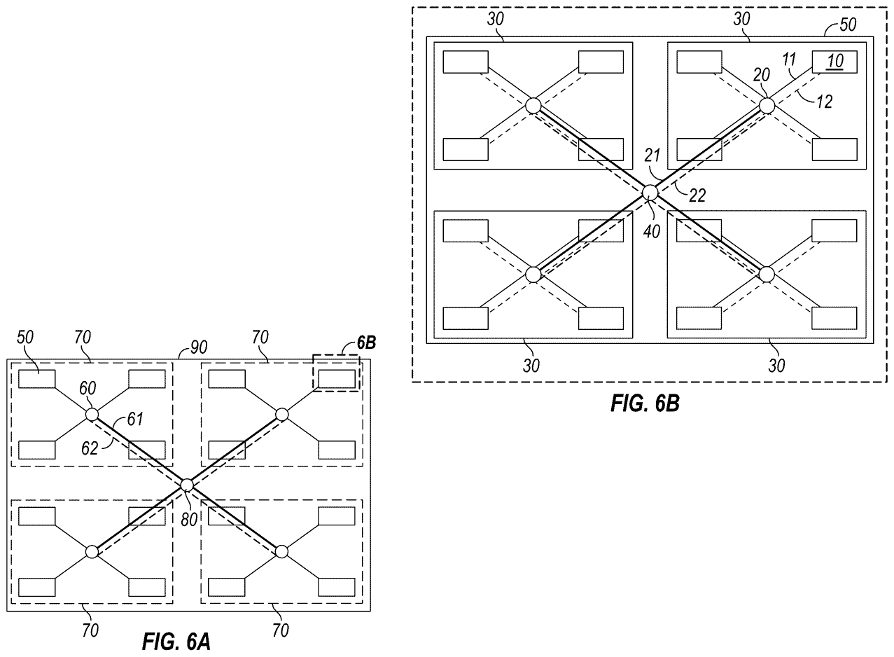

FIG. 6 shows an example direct air capture process including a fractal network layout according to an implementation of the disclosed subject matter. In particular, FIG. 6 shows a plurality of tertiary level units 70 and a plurality of tertiary level nodes 60, each tertiary level unit 70 having a tertiary level node 60. Also shown in FIG. 6, a quaternary level unit 90 may include the plurality of tertiary level units 70 and the plurality of tertiary level nodes 60. A quaternary level node 80 may be located within the quaternary level unit 90. FIG. 6 further shows the elements within a secondary level unit 50, and the secondary level unit 50 may include the plurality of base units 30. Each base unit 30 may include a plurality of DAC modules 10. Also, each base unit 30 may include a primary level node 20. As shown, each primary level node 20 may be connected to each of the DAC modules 10 within each base unit 30 by process connections 11 and/or utility connections 12. Also shown in FIG. 6, a secondary level node 40 may be located in the secondary level unit 50, and the secondary level node 40 may be connected to each of the primary level nodes 20 by process connections 21 between primary level nodes 20 and the secondary level node 40 and/or by utility connections 22 between primary level nodes 20 and the secondary level node 40. The quaternary level node 80 may be connected to any of the plurality of the primary, secondary, and tertiary level nodes (20,40,60) within the quaternary level unit 90 by process connections 61 and/or utility connections 62.

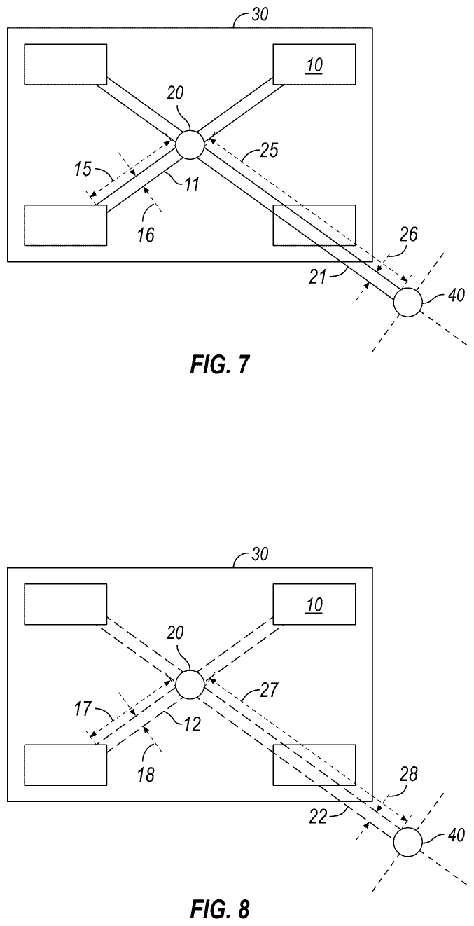

FIG. 7 shows an example direct air capture process including a fractal network layout according to an implementation of the disclosed subject matter. In particular, FIG. 7 shows a base unit 30 which may include a process connection 11 to a primary level node 20 or a process connection 21 to a secondary level node 40. In an embodiment, the process connections 11, 21 may be a piping segment between any of the DAC modules, primary, secondary, tertiary, and quaternary level nodes. As shown in FIG. 7, when the process connection 11 is a piping segment it may have a pipe length 15 measured in km and a pipe diameter 16 measured in inches. As also shown in FIG. 7, when the process connection 21 is a piping segment it may have a pipe length 25 measured in km and a pipe diameter 26 measured in inches. Each piping segment may have a piping segment value which is the product of the pipe length*pipe diameter (km*inches). The sum of all piping segment values in the fractal network layout is minimized relative to a DAC process without a fractal network layout. For example, a network connecting 1024 DAC modules without a fractal layout may have 1056 piping segments of 10 different diameters with a sum of all piping segment values of 794 km*inches. On the other hand, the fractal network layout, according to the present invention, connecting the same 1024 DAC modules may have 1024 piping segments of 5 different diameters with a sum of all piping segment values of 544 km*inches.

FIG. 8 shows an example direct air capture process including a fractal network layout according to an implementation of the disclosed subject matter. In particular, FIG. 8 shows a base unit 30 which may include a utility connection 12 connecting a DAC unit 10 to a primary level node 20. Also shown, the base unit 30 may include a utility connection 22 connecting a primary level node 20 to a secondary level node 40. In an embodiment, the utility connections 12, 22 may be an electrical cable segment between any of the DAC modules, primary, secondary, tertiary, and quaternary level nodes. As shown in FIG. 8, when the utility connection 12 is an electrical cable segment it may have an electrical cable length 17 measured in km and an electrical cable diameter 18 measured in inches. Also shown in FIG. 8, when the utility connection 22 is an electrical cable segment it may have an electrical cable length 27 measured in km and an electrical cable diameter 28 measured in inches. Each electrical cable segment may have an electrical cable segment value which is the product of the electrical cable length*electrical pipe diameter (km*inches). The sum of all electrical cable segment values in the fractal network layout is minimized relative to a DAC process without a fractal network layout. For example, a network connecting 16 DAC modules without a fractal layout may have 20 electrical cable segments of 4 different diameters with a sum of all electrical cable segment values of 1.75 km*inches. On the hand, the fractal network layout, according to the present invention, connecting the same 16 DAC modules may have 16 electrical cable segments of 3 different diameters with a sum of all electrical cable segment values of 1.16 km*inches.

Various utilities, equipment, etc. may be located at a node within the fractal network layout. In an embodiment, the method for operating a direct air capture process including a fractal network layout may include at least one steam generator located at one or more of the primary, secondary, tertiary, and quaternary level nodes, for supplying steam to more than one DAC module via the process connection and/or a utility connection.

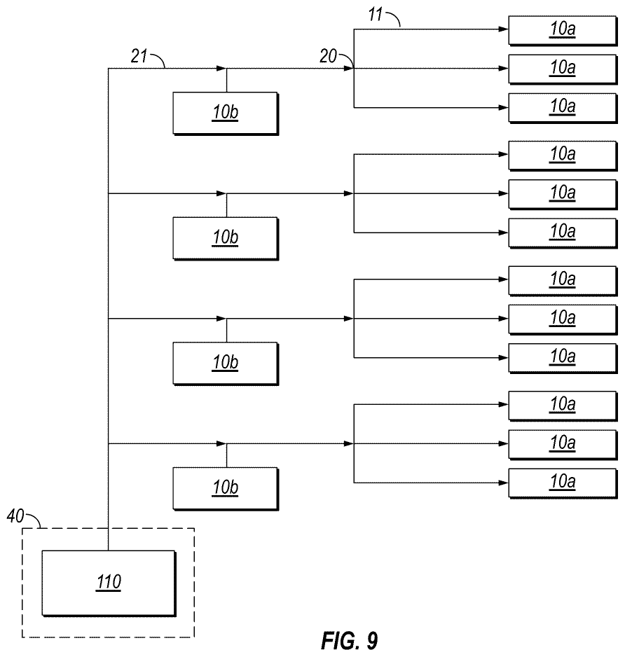

FIG. 9 shows an example direct air capture process including a fractal network layout according to an implementation of the disclosed subject matter. As shown in FIG. 9, a method for operating a direct air capture process including a fractal network layout may include a steam generator 110, to provide heat and stripping gas, located at a secondary node 40. The secondary node 40 including the steam generator 110 may be connected to a plurality of primary level nodes 20 by process connections 21 between the secondary level node 40 and the primary level nodes 20. As shown in FIG. 9, each primary level node 20 may also be connected by process connections 11 to a plurality of DAC modules 10a. Also shown, some DAC modules 10b may be connected to the secondary node 40 by process connection 21.

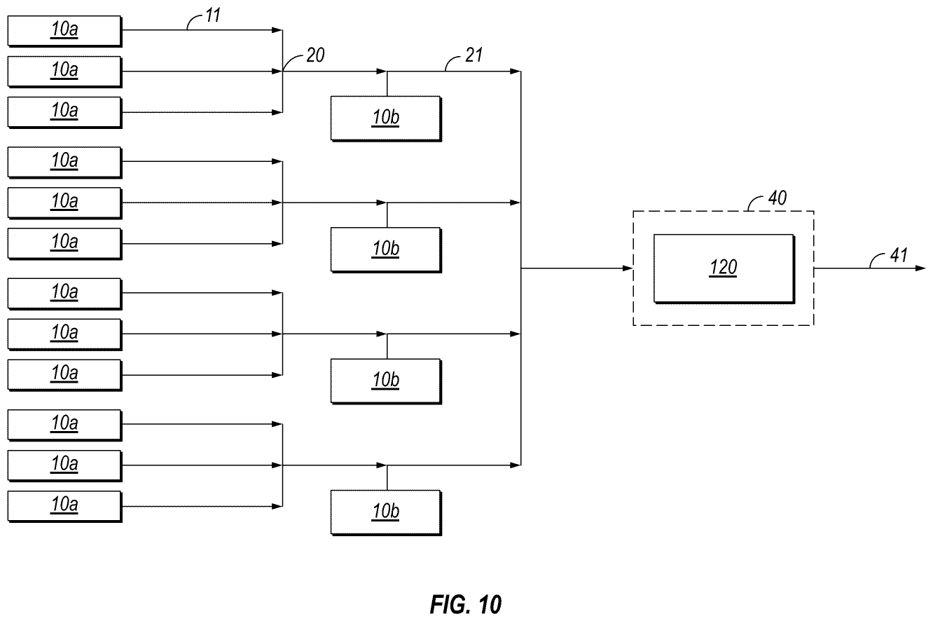

FIG. 10 shows an example direct air capture process including a fractal network layout according to an implementation of the disclosed subject matter. As shown in FIG. 10, a method for operating a direct air capture process including a fractal network layout may include an intermediate compressor 120 to raise the pressure of the outlet stream comprising CO2 being fed to the suction of a main compressor (not shown in FIG. 10). This intermediate compressor 120 may be located at a secondary node 40. The secondary node 40 including the intermediate compressor 120 may be connected to a plurality of primary level nodes 20 by process connections 21 between the secondary level node 40 and the primary level nodes 20. As shown in FIG. 10, each primary level node 20 may also be connected by process connections 11 to a plurality of DAC modules 10a. Also shown, some DAC modules 10b may be connected to the secondary level node 40 by process connection 21. The secondary level node 40 and the intermediate compressor 120 may be connected to a tertiary level node (not shown in FIG. 10) by process connection 41.

Although not shown in FIG. 9 or 10, various utilities, equipment, etc. may be located at any of the nodes within the fractal network layout. For example, a condenser may be located at one or more of the primary, secondary, tertiary, and quaternary level nodes for receiving the outlet stream comprising CO2 from more than one DAC module via the process connections. In an embodiment, at least one energy storage unit located at one or more of the primary, secondary, tertiary, and quaternary level nodes for supplying stored energy to more than one DAC module via the process connection and/or a utility connection.

Furthermore, according to an embodiment, the method for operating a direct air capture process including a fractal network layout may include providing any one or more of: an electric boiler, an energy storage unit comprising a liquid heat storage medium, an air cooler, a liquid ring pump, an electrical substation, and an electrical transformer. One or more of these items may be located at one or more of the primary, secondary, tertiary, and quaternary level nodes for supplying and/or receiving process or utility streams to more than one DAC module via the process and/or utility connections. A process stream may be, for example, steam fed from a boiler directly to the sorbent, or the outlet stream comprising CO2 which is fed to an intermediate compressor. A utility stream may be, for example, steam fed from a boiler for indirect heating of the sorbent, electricity fed from an electrical transformer for heating of the sorbent, or electricity fed from a substation to power other equipment in the DAC module.

For the purposes of promoting an understanding of the principles of the invention, reference will now be made to the Examples carried out of various embodiments of the present invention, which are described in more detail below. The Examples and embodiments disclosed herein are not intended to be exhaustive or limit the invention to the precise form disclosed in the following Examples. The invention includes any alterations and further modifications in the provided Examples and described methods and further applications of the principles of the invention as set forth in the claims.

### EXAMPLES

Comparative Example 1. The steam piping network was calculated for an array of 1024 DAC modules in a square array of 2 km*2 km, with a central steam generator. Total steam flow was 800 ton/hour, pressure at the steam generator was 3 bara, and a pressure drop to the most distant DAC module was 0.2 bar. The steam piping network was calculated for a network with a main piping segment running across the center of the array, parallel to one side, with 64 sub-piping segments orthogonal to the main piping segment, each reaching 16 DAC modules. For this orthogonal network the total length of piping was 66 km and the sum of all piping segment values was 794 km*inches.

Example 1. The steam piping network was calculated for the same array as in Comparative Example 1, an array of 1024 DAC modules in a square array of 2 km*2 km, with a central steam generator. Total steam flow was 800 ton/hour, pressure at the steam generator was 3 bara, and a pressure drop to the most distant module was 0.2 bar. The fractal piping network, according to the present invention, connected the steam boiler to four quaternary level nodes and intermediate tertiary level nodes, secondary level nodes, primary level nodes and DAC modules. Each quaternary level node was connected to a further three tertiary level nodes and intermediate secondary and primary level nodes and DAC modules. Each tertiary level node was connected to a further three secondary level nodes and intermediate primary level nodes and DAC modules. Each secondary level node was connected to a further three primary level nodes and an intermediate DAC module. For this fractal piping network, the total length of piping was 60 km and the sum of all piping segment values was 544 km*inches.

Comparison of the results of Comparative Example 1 and Example 1 demonstrates at least one of the advantages of the invention. As explained above, the orthogonal network in the Comparative Example 1 required a piping segment value of 794 km*inches. Whereas the fractal network layout according to the present invention in Example 1 required a piping segment value of 544 km*inches. This shows more than a 30% reduction in piping segments needed for operating the same DAC module array by utilizing the fractal network layout according to the present invention. As the cost of a piping network is proportional to the sum of all piping segments in km*inches, comparison of these results demonstrates that the cost of the fractal piping network is less than 70% of the cost of the orthogonal network.

Comparative Example 2. The electrical cable network was calculated for an array of 16 DAC modules in a square array of 0.5 km*0.5 km, with a central transformer. Total electricity supply was 1170 kW at 400 V. The electrical cable network was calculated for a network with a main cable segment running across the center of the array, parallel to one side, with 8 sub-cable segments orthogonal to the main cable segment, each reaching two DAC modules. For this orthogonal network the total length of electrical cable was 2.5 km and the sum of all electrical cable segment values was 1.75 km*inches.

Example 2. The electrical cable network was calculated for the same array as in Comparative Example 2, for an array of 16 DAC modules in a square array of 0.5 km*0.5 km, with a central transformer. Total electricity supply was 1170 kW at 400 V. The fractal network layout with an electrical cable connecting the central transformer, located at a secondary level node, to four primary level nodes and intermediate DAC modules. The primary level nodes were each connected to a further three DAC modules. For this fractal network layout the total length of electrical cable was 1.8 km and the sum of all electrical cable segment values was 1.16 km*inches.

Comparison of the results of Comparative Example 2 and Example 2 demonstrates at least one advantage of the invention. As explained above, the orthogonal network in the Comparative Example 2 required an electrical cable segment value of 1.75 km*inches. Whereas the fractal network layout according to the present invention in Example 2 required an electrical cable segment value of 1.16 km*inches. This shows more than a 30% reduction in electrical cable segments needed for operating the same DAC module array by utilizing the fractal network layout according to the present invention. As the cost of an electrical cable network is proportional to the sum of all electrical cable segments in km*inches, comparison of these results indicates that the cost of the fractal electrical cable network is less than 70% of the cost of the orthogonal network.

Example 3. The steam piping network was calculated for the same array as in Example 1, an array of 1024 DAC modules in a square array of 2 km*2 km, except that the location of the steam boiler was varied between the primary, secondary, tertiary, and quaternary level nodes. The total heating duty required was 512 MW and the steam generator was made up of multiple boilers with a maximum capacity of a single boiler of 32 MW. A 32 MW boiler costs $2 million, and the cost of a boiler with a lower capacity than 32 MW is the ratio of that lower capacity to 32 MW raised to the power of 0.65, multiplied by $2 million. Cost of piping in the fractal network was $100,000 per km*inches, including all interconnections at nodes and at DAC modules. The following table shows the total cost for various scenarios where the boilers are located at different level nodes.

TABLE 1
Example costs of steam boiler location in a fractal network
layout according to the disclosed subject matter.

| | Primary level | Secondary | Tertiary | Quaternary | Centre of |
|---|---|---|---|---|---|
| Location of boilers | node | level node | level node | level node | array |
| Cost of piping | $11,434,917 | $22,338,950 | $32,973,528 | $43,637,949 | $54,364,890 |
| Cost of boilers | $84,448,506 | $51,984,153 | $32,000,000 | $32,000,000 | $32,000,000 |
| Total cost | $95,883,423 | $74,323,103 | $64,973,528 | $75,637,949 | $86,364,890 |

Examination of the results in Example 3 shows that piping costs reduce progressively as the steam boiler location is changed from the center of the array to a quaternary level node, then to a ternary level node, then to a secondary level node, and then to a primary level node. In contrast, the cost of the steam boilers remains the same between the center of the array, the quaternary level node, and the tertiary level node. The cost of the steam boiler then increases as the steam boiler location is changed to the secondary and primary level nodes. As shown in Table 1 above, there is a lower overall cost (piping+steam boilers) when locating the steam boilers at the secondary, tertiary or quaternary level nodes, as compared to location at the primary level node and center of the array. In this example above, the optimal location is at the tertiary level node.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method for operating a direct air capture process including a fractal network layout, the method comprising:
a) providing a plurality of base units, wherein each base unit comprises a plurality of direct air capture (DAC) modules;
b) providing a plurality of primary level nodes, wherein each base unit includes a primary level node, and wherein each primary level node is connected to each of the DAC modules within the base unit by a process connection and/or a utility connection;
c) providing a secondary level unit, wherein the secondary level unit comprises the plurality of base units;
d) providing a secondary level node located in the secondary level unit, wherein the secondary level node is connected to each of the primary level nodes within the secondary level unit by a process connection and/or a utility connection;
e) receiving an air stream at each of the direct air capture (DAC) modules;
f) contacting the air stream with a sorbent material located within each of the direct air capture (DAC) modules; and
g) generating an outlet stream comprising CO2 from each of the direct air capture (DAC) modules and transporting the outlet stream to the secondary level node.

2. The method for operating a direct air capture process including a fractal network layout according to claim 1, wherein the method further comprises:
a) providing a plurality of secondary level units and a plurality of secondary level nodes, each secondary level unit having a secondary level node;
b) providing a tertiary level unit, wherein the tertiary level unit comprises the plurality of secondary level units and the plurality of secondary level nodes;
c) providing a tertiary level node located in the tertiary level unit, wherein the tertiary level node is connected to the plurality of the primary and secondary level nodes within the tertiary level unit by a process connection and/or a utility connection.

3. The method for operating a direct air capture process including a fractal network layout according to claim 2, wherein the method further comprises:
a) providing a plurality of tertiary level units and a plurality of tertiary level nodes, each tertiary level unit having a tertiary level node;
b) providing a quaternary level unit, wherein the quaternary level unit comprises the plurality of tertiary level units and the plurality of tertiary level nodes;
c) providing a quaternary level node located within the quaternary level unit, wherein the quaternary level node is connected to the plurality of the primary, secondary, and tertiary level nodes within the quaternary level unit by a process connection and/or a utility connection.

4. The method for operating a direct air capture process including a fractal network layout according to claim 3, wherein one or more of the process connections comprises a piping segment between any of the DAC modules, primary, secondary, tertiary, and quaternary level nodes, wherein each piping segment has a pipe length measured in km and a pipe diameter measured in inches, wherein each piping segment has a piping segment value which is the product of the pipe length*pipe diameter (km*inches).

5. The method for operating a direct air capture process including a fractal network layout according to claim 3, wherein one or more of the utility connections comprises an electrical cable segment between any of the DAC modules, primary, secondary, tertiary, and quaternary level nodes, wherein each electrical cable segment has an electrical cable length measured in km and an electrical cable diameter measured in inches, wherein each electrical cable segment has an electrical cable segment value which is the product of the electrical cable length*electrical cable diameter (km*inches).

6. The method for operating a direct air capture process including a fractal network layout according to claim 1, wherein the method further comprises providing at least one steam generator located at one or more of the primary, secondary, tertiary, and quaternary level nodes, for supplying steam to more than one DAC module via the process connections.

7. The method for operating a direct air capture process including a fractal network layout according to claim 1, wherein the method further comprises providing at least one intermediate compressor located at one or more of the primary, secondary, tertiary, and quaternary level nodes for receiving the outlet stream comprising CO2 from more than one DAC module via the process connections.

8. The method for operating a direct air capture process including a fractal network layout according to claim 1, wherein the method further comprises providing at least one condenser located at one or more of the primary, secondary, tertiary, and quaternary level nodes for receiving the outlet stream comprising CO2 from more than one DAC module via the process connections.

9. The method for operating a direct air capture process including a fractal network layout according to claim 1, wherein the method further comprises providing at least one energy storage unit located at one or more of the primary, secondary, tertiary, and quaternary level nodes for supplying stored energy to more than one DAC module via the process and/or utility connections.

10. The method for operating a direct air capture process including a fractal network layout according to claim 1, wherein the method further comprises providing at least one selected from the group consisting of: an electric boiler, an energy storage unit comprising a liquid heat storage medium, an air cooler, a liquid ring pump, an electrical substation, and an electrical transformer, located at one or more of the primary, secondary, tertiary, and quaternary level nodes for supplying and/or receiving process or utility streams to more than one DAC module via the process and/or utility connections.
